(19) United States
(12) Patent Application Publication
(10) Pub. No.: US 2005/0060388 A1
(43) Pub. Date: Mar. 17, 2005

(54) Method for modifying computer configuration and configuration of program which operates on computer, and computing device and system for implementing the method

(75) Inventors: Akio Tatsumi, Yokohama (JP); Hiroyuki Kumazaki, Yokohama (JP); Yuuichirou Kuma, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/648,824

(22) Filed: Aug. 25, 2003

(30) Foreign Application Priority Data
Aug. 26, 2002 (JP) 2002-244471

(51) Int. Cl. G06F 15/177

(52) U.S. Cl. 709/220

(57) ABSTRACT

This invention relates to modifying hardware and program configuration of a computer. In one embodiment, a computer configuration modification method comprises, upon reception of a configuration modification request for the hardware configuration and program configuration of the computer to be modified, transmitting the information regarding the hardware configuration to be modified to a hardware contract renewal notification destination in order to modify the fee to be paid for the modified hardware, and transmitting the information regarding the hardware configuration to be modified and the information regarding the program configuration to be modified to a program contract renewal notification destination in order to modify the fee to be paid for the modified program. When license information transmitted from the program contract renewal notification destination is inputted, the hardware configuration is modified based on the information regarding the hardware configuration to be modified and the program configuration is modified based on the information regarding the hardware configuration to be modified and the information regarding the program configuration to be modified.

### CROSS-REFERENCES TO RELATED APPLICATIONS

This application relates to and claims priority from Japanese Patent Application No. 2002-244471, filed on Aug. 26, 2002, the entire disclosure of which is incorporated herein by reference.

### BACKGROUND OF THE INVENTION

1. Field of the Invention

The present invention relates to a configuration modification technique for modifying the configuration of computer hardware and a program.

2. Description of the Related Art

A general feature of computer usage contracts known as capacity on demand (to be abbreviated to COD hereinafter) is that a hardware vendor provides a client with a computing system in which a part of the hardware resources, for example the CPU, memory, or hard disk (to be abbreviated to HD hereinafter), cannot be used. At that time, the client does not pay for all of the provided hardware resources, but pays for and uses only the usable parts (often at a somewhat high cost, to be precise). If the client uses the computer over a long period of time, he or she may confront a lack of hardware capacity due to increases in workload or the like. At this time, the client may instruct that the hardware resources such as CPUs that could not be used up to this point be activated for use. A usage fee for the activated parts is then paid to the hardware vendor.

Before COD became available for use, a client who wished to increase hardware throughput had to wait a long time for expansion work to be performed by the hardware vendor while operations were halted. In configuration modification techniques such as COD, hardware can generally be activated by inputting a command or setting a simple device such that hardware is augmented simply be rebooting. Although examples thereof are few, devices which enable throughput enhancement without the need to reboot are also known.

In COD, when a hardware activation instruction is issued, a method exists for informing a hardware vendor via a network that “hardware has been activated by COD”. Thus the hardware vendor is able to charge a usage fee for the computer on the basis of the hardware configuration following COD implementation. A method for preventing unauthorized usage is known in which all hardware resources are assumed to be activated and an appropriate charge is applied when the system of a client who has a COD contract becomes incapable of communication with the hardware vendor system.

### SUMMARY OF THE INVENTION

In conventional COD, hardware capacity augmentation can be achieved in a short time period since there is no need to await the arrival of components or the completion of expansion work. However, the following two problems have arisen in programs operating on this hardware.

Firstly, adding hardware resources does not necessarily mean that a program which operates on the hardware is able to use the enhanced capabilities brought about by the addition of hardware resources. In the case of a parallel application program, for example, which activates a number of processes equivalent to the number of CPUs such that all of the CPUs are used simultaneously, the number of CPUs is increased due to COD, but the application program does not automatically use all of the CPUs. As a result, the client must manually stop and restart the application program and modify the configuration definition.

Secondly, a problem arises with the fact that in order to prevent unauthorized usage, a safeguard is provided such that the program itself recognizes the hardware configuration and does not operate on hardware beyond the hardware in the agreed configuration. Data known as a license key are usually used for this safeguard. In this case, the license key serves to inform the program of the hardware configuration for which activation permission has been given, and the program is coded so as to operate only on the hardware configuration determined or managed by the license key. For example, programs in which usage fees change according to the number of CPUs include a program which obtains the number of activated computer CPUs and ceases operations on a computer with a higher number of CPUs than that permitted by the contract and determined by the license key, and a program which is limited to an activation capacity within the range permitted by the license key. In a system which operates this type of program, if the number of CPUs is increased by mistake prior to obtaining an appropriate license key, situations such as being unable to perform work until the license key is obtained arise. Further, even if a client him/herself realizes that post-COD implementation license keys must be obtained in advance, a time lag occurs when the client wishes to implement COD since the client must contact each application program vendor, negotiate fees, and wait for the license keys to be distributed. As a result, capacity expansion at any time, which is the original object of COD, cannot be realized.

In short, COD at present is only capable of realizing “immediate hardware augmentation,” and is not capable of realizing the essential objective of “immediate improvement of production performance for a client.”

A feature of the present technique is to provide a computer configuration modification method and system for modifying the capacity of a program to reflect a hardware configuration modification.

In order to solve the aforementioned problems according to an embodiment of the present technique, a computer configuration modification system comprising a computer system having a modifiable configuration, a hardware management system for performing billing in accordance with the hardware configuration of this computer, and a program management system for performing billing in accordance with the program configuration of this computer, performs the following processing:
1. when a configuration modification request for the hardware configuration and program configuration of the computer system requiring configuration modification is inputted, the computer system transmits information regarding the hardware configuration to be modified to the hardware management system in order to modify the fee to be paid following hardware configuration modification, and transmits to the program management system information regarding the program configuration to be modified together with the information regarding the hardware configuration to be modified in order to modify the fee to be paid following program configuration modification;
2. when the information regarding the hardware configuration to be modified is inputted, the hardware management system modifies the fee to be paid for the hardware on the basis of this hardware configuration information and transmits hardware billing information to the computer;
3. when the information regarding the hardware configuration to be modified and the information regarding the program configuration to be modified is inputted, the program management system modifies the fee to be paid for the program on the basis of this hardware configuration information and program configuration information and transmits program billing information to the computer; and
4. when the hardware billing information and program billing information are inputted, the computer modifies the hardware configuration on the basis of the information regarding the hardware configuration to be modified and modifies the program configuration on the basis of the information regarding the program configuration to be modified.

In this manner, a computer configuration modification method and system for modifying the capacity of a program to reflect a hardware configuration modification are realized.

In accordance with another aspect of the technique, a computer configuration modification method comprises storing hardware configuration information comprising information regarding hardware configuration of a computer, a hardware contract renewal notification destination for the hardware of the computer, information regarding program configuration of the computer, and a program contract renewal notification destination for the program of the computer. Upon reception of a configuration modification request for the hardware configuration and program configuration of the computer to be modified, the method further includes transmitting the information regarding the hardware configuration to be modified to the hardware contract renewal notification destination in order to modify the fee to be paid for the modified hardware, and transmitting the information regarding the hardware configuration to be modified and the information regarding the program configuration to be modified to the program contract renewal notification destination in order to modify the fee to be paid for the modified program. When license information transmitted from the program contract renewal notification destination is inputted, the hardware configuration is modified based on the information regarding the hardware configuration to be modified and the program configuration is modified based on the information regarding the hardware configuration to be modified and the information regarding the program configuration to be modified.

### BRIEF DESCRIPTION OF THE DRAWINGS

FIG. 1 is a block diagram showing the overall constitution of an embodiment of the present technique;

FIG. 2 is a timing chart illustrating the sequence in which each communicating block operates;

FIG. 3 is a flowchart of an HW-COD implementation control unit inside a client system and a COD implementation notification reception unit on an HW vendor side;

FIG. 4 is a flowchart of an AP-COD implementation control unit inside a client system, a COD implementation notification reception unit on an AP vendor side, and an AP license management unit inside the client system;

FIG. 5 is a flowchart of an AP billing management unit on the AP vendor side;

FIG. 6 is a flowchart of an embodiment of an AP;

FIG. 7 is a flowchart of a different embodiment of an AP from that shown in FIG. 6;

FIG. 8 is a view of a COD-DB for storing information relating to COD on the HW vendor side; and

FIG. 9 is a view of a COD-DB for storing information relating to COD on the AP vendor side.

### DESCRIPTION OF THE PREFERRED EMBODIMENTS

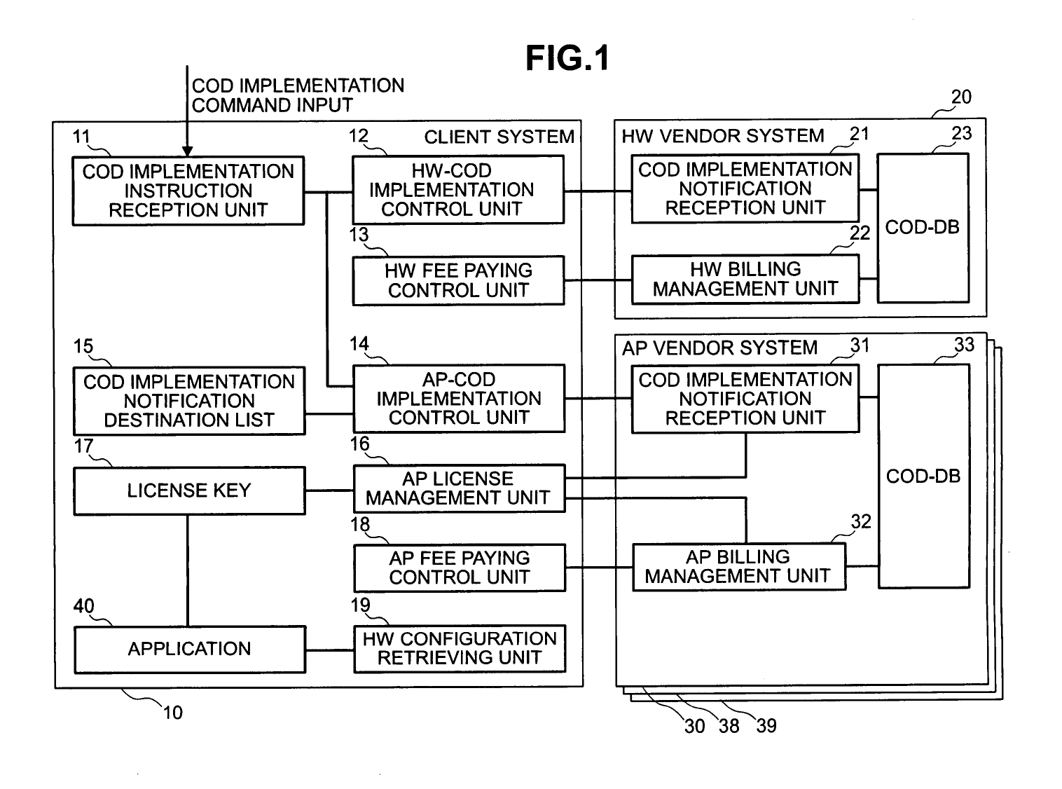

FIG. 1 is a block diagram showing an embodiment of the invention, comprising a client system 10 to which a COD usage contract has been applied, an HW vendor system 20, and AP vendor systems 30, 38, 39. In this embodiment, COD is described as an example of a configuration modification request or a capacity modification request, but this embodiment is not limited to COD and may be applied to any system in which hardware or program configuration or capacity is modified by a configuration modification request or a capacity modification request.

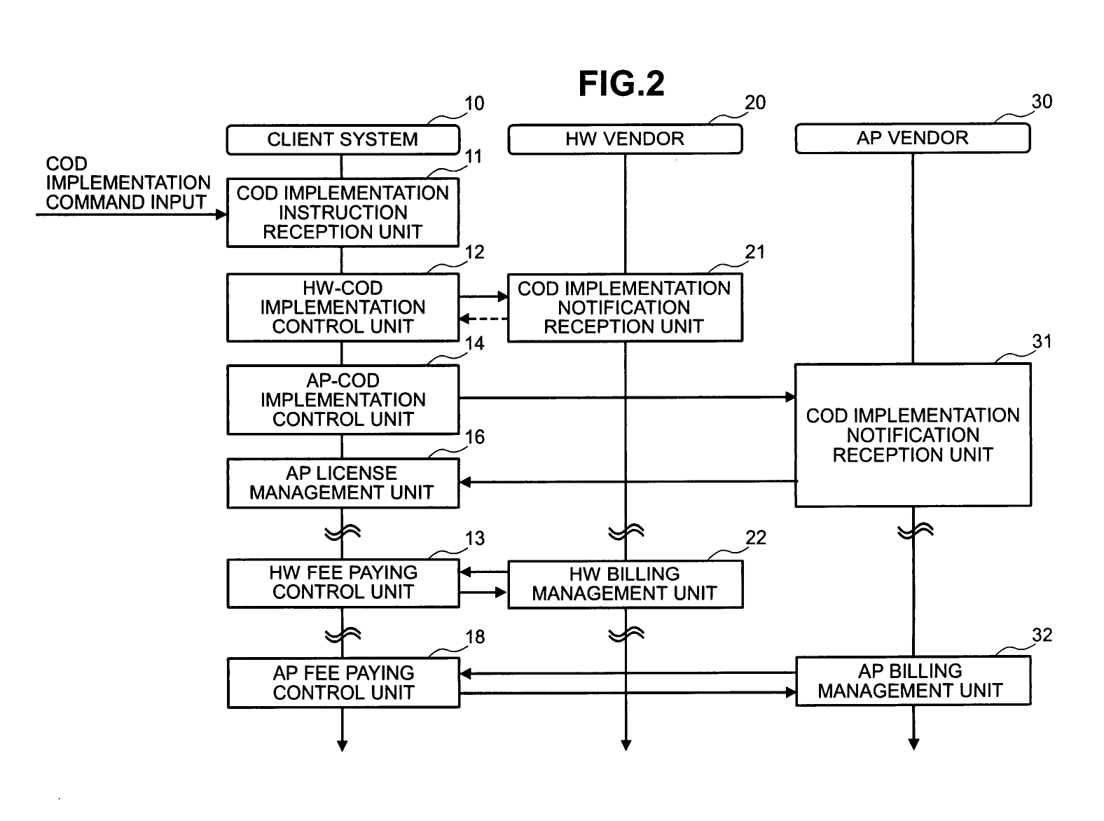

FIG. 2 is a view illustrating the sequence in which communication between the client system 10, HW vendor system 20, and AP vendor system 30 is activated, and is an outline of the flow of processing to be described herein below. When a COD implementation command (either a configuration modification request or a capacity modification request may be used) is inputted, a COD implementation instruction reception unit 11 detects the command, and an HW-COD implementation control unit 12 informs a COD implementation notification reception unit 21 on the HW vendor 20 side that COD has been implemented. An AP-COD implementation control unit 14 then informs a COD implementation notification reception unit 31 on the AP vendor 30 side that COD has been implemented. A license key is then transmitted from the AP vendor 30 to an AP license management unit 16 within the client system. Thereafter, fee billing and payment thereof are performed between an HW billing management unit 22 and an HW fee paying unit 13. Fee billing and payment thereof are also performed between an AP billing management unit 32 and an AP fee paying control unit 18 independently of the HW fee payment. Alternatively, the HW vendor 20 may generate a separate HW license key when the COD implementation notification reception unit 21 receives notification that COD has been implemented, and transmit the HW license key to the client system 10, as illustrated by the broken line arrow in FIG. 2. In that case, the configuration of the computer will be modified based on the HW license key generated by the HW vendor 20 and the AP license key generated by the AP vendor 30.

When, in FIG. 1, an instruction to implement COD is issued from the client system 10, the COD implementation instruction reception unit 11 detects this instruction. The instruction is then issued from the COD implementation instruction reception unit 11 to the HW-COD implementation control unit 12.

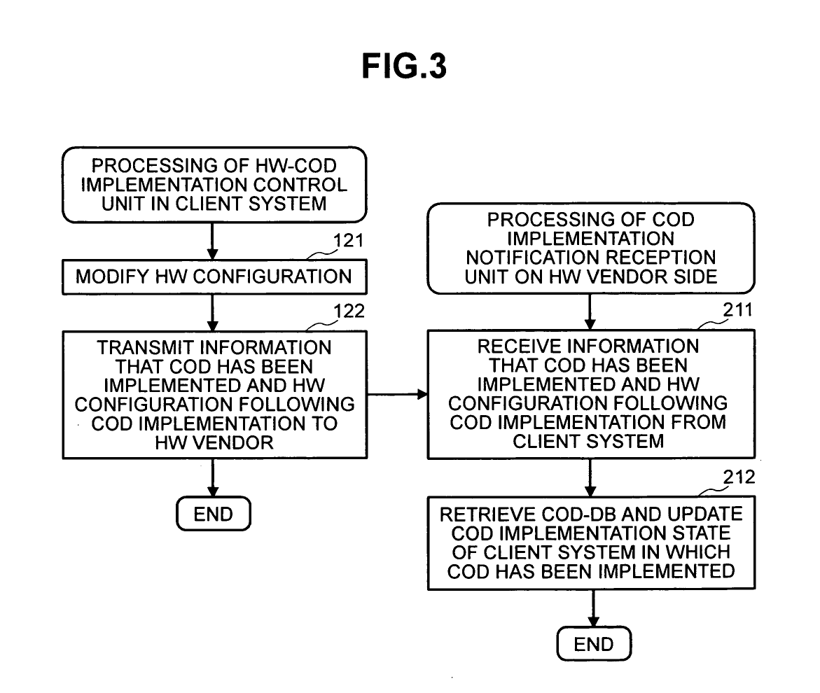

FIG. 3 is a flowchart of the HW-COD implementation control unit 12 and the COD implementation notification reception unit 21. First, when the HW-COD implementation control unit 12 receives the instruction from the COD implementation instruction reception unit 11, the hardware configuration is modified in a step 121. Next, in a step 122, the HW vendor 20 is informed of the COD implementation and the manner in which the hardware configuration has been altered by the COD implementation.

On the HW vendor 20 side, the notification of COD implementation in step 122 is received in the COD implementation notification reception unit 21. Following reception of the COD implementation information in a step 211, the state of the hardware configuration in each client system is reflected in a managing COD-DB 23 in a step 212.

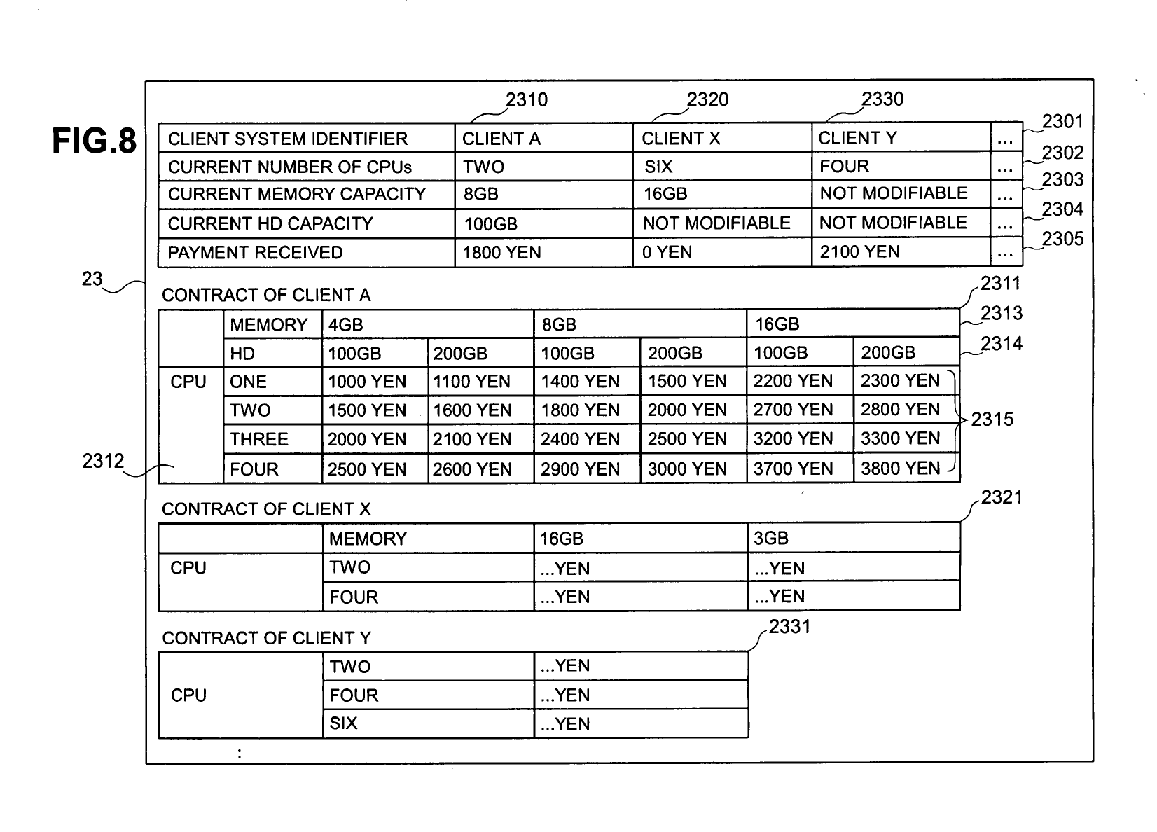

FIG. 8 illustrates the constitution of the COD-DB 23 on the HW vendor 20 side. A client system identifier 2301 is provided for each client, and entries 2310, 2320, and 2330 are provided for a client A, a client X, and a client Y respectively. Items indicating the current COD implementation state, in this case the number of CPUs 2302, memory capacity 2303, HD capacity 2304, and payment received 2305, are stored for each client. Values for CPU 2312, memory 2313, and HD 2314, which are indices showing the COD implementation state, and a fee 2315 corresponding to each COD state are also stored for each client. In the current contract of client A, the number of CPUs is two, the memory capacity is 8 GB, and the HD capacity is 100 GB, and hence a usage fee of 1800 yen is charged to the contract 2311 of client A. As shown in FIG. 8, the billable items may differ among the clients A, X, and Y. Billing of a computer usage fee is performed between the billing management unit 22 and the HW fee paying unit 13 on the basis of the fees for each COD implementation state which are stored in the COD-DB 23.

Increases and decreases in hardware resources by COD usually require rebooting to become effective, but the resource quantity may be modified without rebooting.

A feature of the present embodiment is that COD implementation notification is also performed in the AP vendors 30, 38, 39. A notification destination list 15 containing all of the application program vendors to be notified of COD implementation is stored in the client system 10, and when COD is implemented, all of the registered vendors are notified thereof. In FIG. 1, three AP vendors are listed as an example, but since the contents of 38 and 39 are identical to that of 30, description thereof has been omitted. Hereafter, description will be provided only for the AP vendor 30, but the content of this description applies equally to the other vendors 38, 39. Here, an application program is described as an example, but the present embodiment is applicable to programs in general and not limited to an application program.

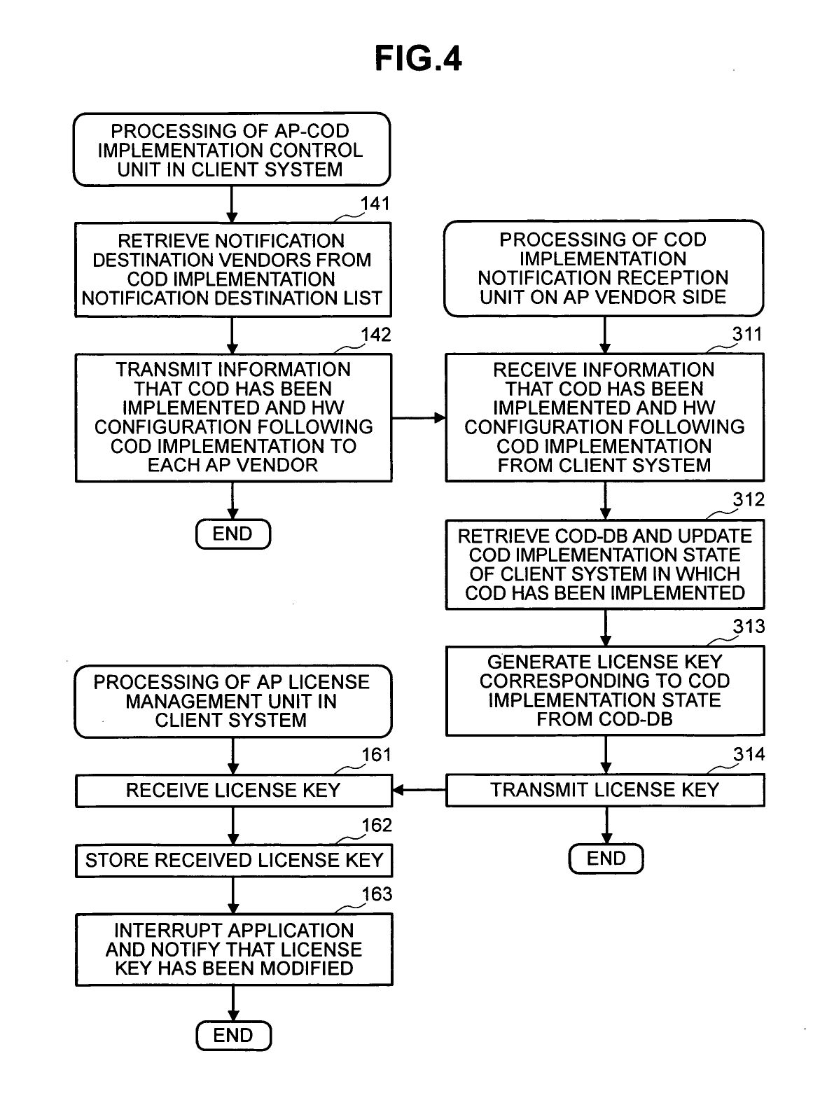

When COD implementation is detected in the COD implementation instruction reception unit 11, an instruction is also performed in the AP-COD implementation control unit 14. FIG. 4 is a flowchart of the AP-COD implementation control unit 14 within the client system, the COD implementation notification reception unit 31 on the AP vendor side, and the AP license management unit 16 inside the client system. In the AP-COD implementation control unit 14, notification destinations are obtained from the COD implementation notification destination list 15 in a step 141, and in a step 142, each notification destination is informed of the manner in which the hardware configuration has changed following COD implementation.

On the AP vendor 30 side, notification is received in the AP-COD implementation notification reception unit 31. Following reception of COD implementation notification and the hardware configuration following implementation in a step 311, the hardware configuration state of each client is reflected in a managing COD-DB 33 in a step 312. Then, in a step 313 a license key 17 is generated in accordance with the COD implementation state, and in a step 314 the license key 17 is transmitted to the AP license management unit 16 in the client system 10. The license key 17 is constituted by the state of the hardware resources subject to COD such as CPUs, memory, and HD, a period of validity, and the like. An embodiment in which these items are encoded or a method of defining the items in advance using random numbers or the like and storing the items in the COD-DB 33 is also possible.

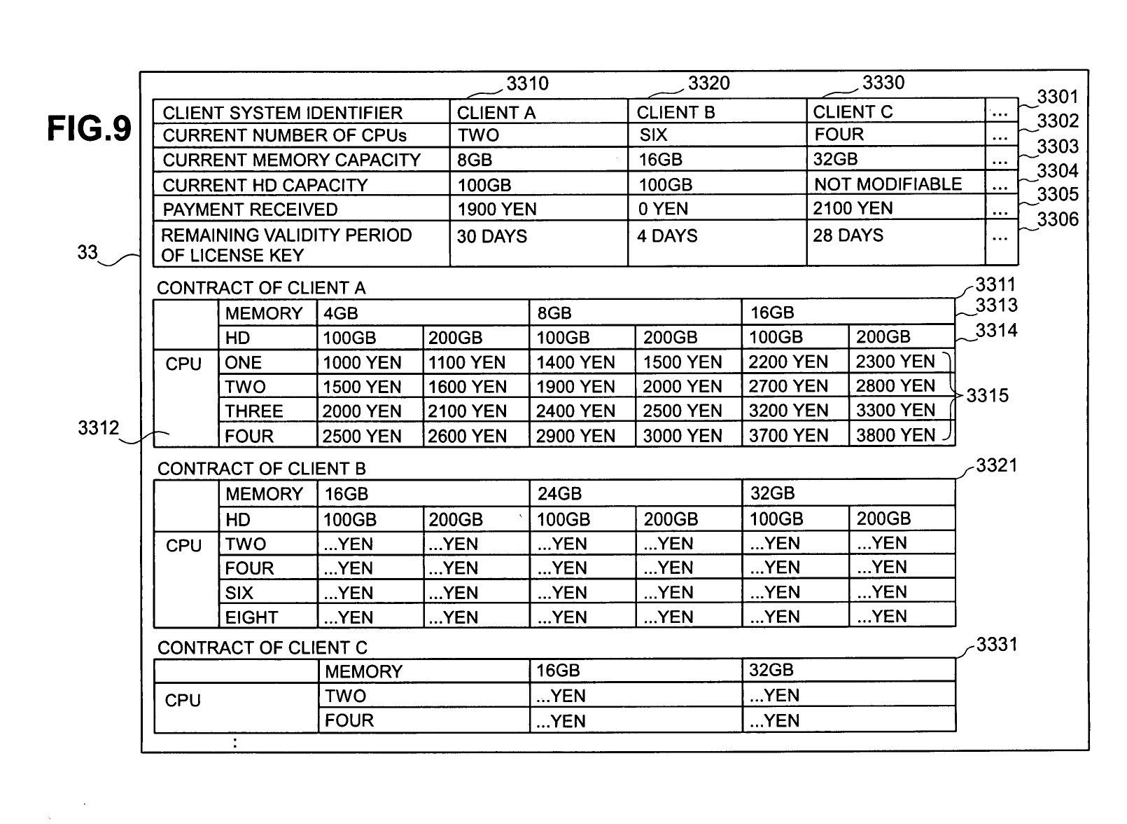

FIG. 9 shows the constitution of the COD-DB 33 on the AP vendor side 30. Entries 3310, 3320, and 3330 for each client are provided in respect of a client system identifier 3301. Items indicating the current COD implementation state, in this case the number of CPUs 3302, memory capacity 3303, HD capacity 3304, payment received 3305, and a remaining period of license key validity 3306 are stored for each client. Values for CPU 3312, memory 3313, and HD 3314, which are indices showing the COD implementation state, and a fee 3315 corresponding to each COD state are also stored for each client. In the current contract of client A, the number of CPUs is two, the memory capacity is 8 GB, and the HD capacity is 100 GB, and hence a usage fee of 1900 yen is charged to the contract 3311 of client A. As shown in FIG. 9, the billable items may differ among the clients A, X, and Y.

In the client system 10, the license key 17 is received by the AP license management unit 16. Once the license key has been received in a step 161, the license key 17 is stored in a step 162. In a step 163, the application program 40 is notified that the license key has been modified. The license key 17 is normally encoded and stored in a configuration definition file, but this example is merely illustrative and does not limit the method in the present embodiment.

Another feature of the present embodiment, as described above, is that the application program 40 is notified of COD implementation in step 163 of the AP license control unit 16.

A further one of the features of the present embodiment is that when the hardware resources are increased or decreased following COD implementation without halting the application program 40 or the OS, and when the amount of hardware resources is increased or decreased following COD implementation while the application program 40 is in operation, the hardware resources following COD implementation may be used without halting the application program 40. This embodiment will be described herein below.

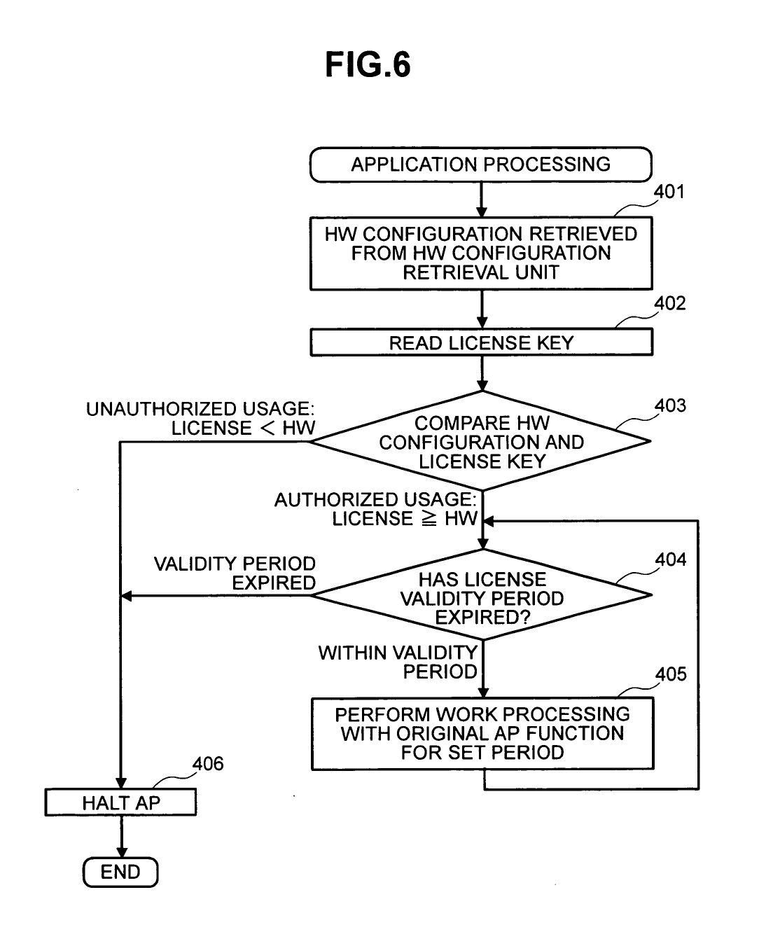

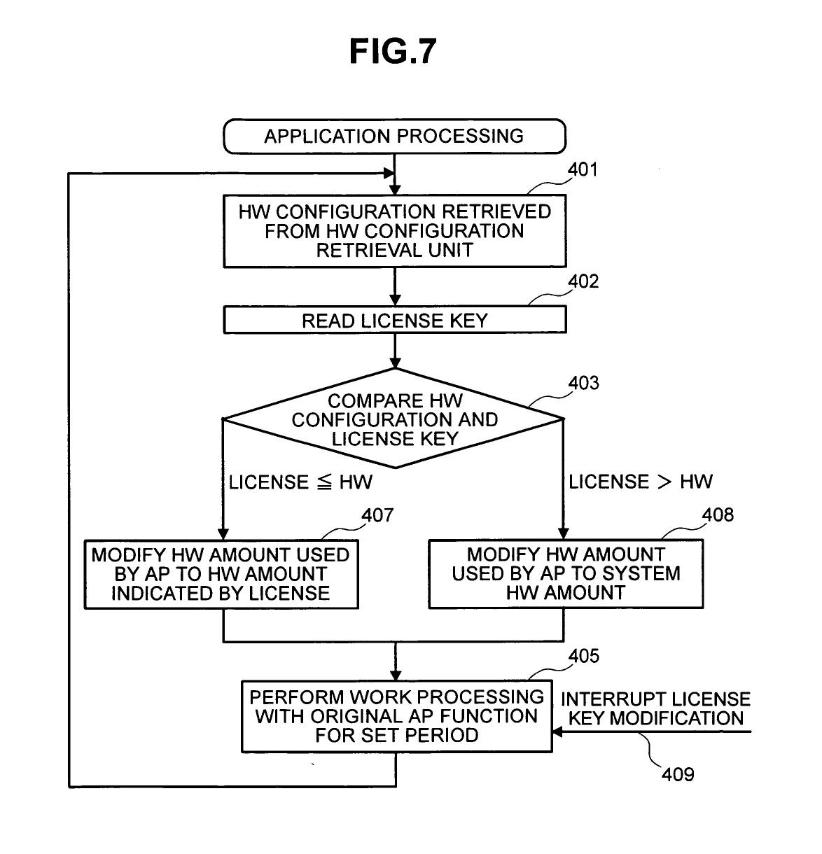

Next, the two embodiments of FIGS. 6 and 7 will be described with the application program 40 as an example. The application program to be described herein below is one embodiment thereof and does not limit the scope of the present invention.

FIG. 6 is a flowchart showing one embodiment of the application program 40. Upon activation, the application program 40 obtains the hardware configuration from a HW configuration retrieval unit 19 in a step 401, and in a step 402 obtains the license key 17. Then, in a step 403, the hardware configuration indicated by the license key 17 in which the application program 40 is permitted to operate is compared to the actual hardware configuration to be operated in order to check for unauthorized usage. If, for example, the license key 17 permits operations on up to four CPUs, but in actuality eight CPUs are in operation, unauthorized usage is determined. At this time, the application program 40 is halted, for example, in a step 406. Conversely, if the actual hardware configuration and the configuration indicated by the license key 17 match, for example, authorized usage is determined and the period of validity comprised in the license key 17 is checked in a step 404. If the period of validity of the license key 17 has expired, it is determined that usage is unauthorized and the application program 40 is halted in a step 406. If the period of validity has not expired, work processing corresponding to the original operation of the application program 40 is performed in a step 405. Note that since the period of validity of the license key 17 must be checked with the passing of time, the work processing of step 405 is halted temporarily once a day, for example, in order to return to step 404 to check the period of validity.

FIG. 7 is a flowchart showing a different aspect of the application program 40 of FIG. 6. In this example, an “application program which can be operated while the amount of hardware in use is modified in accordance with COD implementation” is shown.

Similarly to FIG. 6, steps 401 and 402 indicate processing for obtaining the hardware configuration and the license key 17. The application program 40 of this embodiment determines an available hardware usage amount using the hardware configuration information indicated by the license key 17. An example of this method is illustrated by steps 403, 407, and 408. In step 403, the hardware configuration indicated by the license key 17 in which the application program 40 is permitted to operate is compared to the actual hardware configuration to be operated. If the application program 40 is activated on hardware beyond the hardware configuration indicated by the license key 17, the amount of hardware used by the application program 40 is determined in accordance with the license key 17 in step 407. Conversely, if the license key 17 indicates a hardware configuration which is larger than the actual hardware configuration, the hardware configuration is determined in step 408 such that the amount of hardware used by the application program 40 equals the actual hardware configuration. If, for example, the license key 17 indicates permission for up to four CPUs to be operated but eight CPUs are being used in the hardware configuration, processes are activated on only four CPUs (step 407). If, on the other hand, the license key 17 indicates permission for up to eight CPUs but only four CPUs are being used in the hardware configuration, processes are activated on only the four CPUs that are authorized (step 408). Work processing is then performed in step 405. The configuration modification in these embodiments includes both capacity modification and capability modification.

When COD is implemented, an interruption 409 is generated during the work processing of step 405 so that notification can be given that the license key 17 has been modified. In this case, interruption processing causes processing to return to the beginning of step 401.

An example in which memory is increased and an example in which CPUs are increased will be described below according to each of the steps in FIG. 7. An application program 40 of a type which determines an operating region for work processing in accordance with the system memory is envisaged as an example in which memory is increased. In order to create a load module or fixed region of the OS usage amount or the application program 40 itself, 0.5 GB+a quarter of the system memory of the application program 40 is subtracted as a nonusable region and the remaining part is allocated to work processing. In the case of a computer installed with 4 GB of memory, information indicating a memory amount of 4 GB is obtained in step 401, and in step 402 information indicating that the license key 17 permits operations using 4 GB of memory is obtained. According to the determination in step 403, “HW configuration=license key”, and therefore processing moves to step 407. In step 407, 0.5+1 GB is subtracted as the nonusable region in accordance with the 4 GB indicated by the license key 17, and 2.5 GB is allocated as the operating region of the application program 40. In step 405, 2.5 GB is used to perform work processing.

If COD is implemented during the work processing in step 405 to increase the memory to 16 GB, the hardware configuration becomes 16 GB and the license key 17 begins to indicate 16 GB. The application program 40 is then interrupted in step 409. The steps are then retraced in succession, and in step 407, 0.5+4 GB is subtracted as the nonusable region in accordance with the setting when the application program 40 operates at 16 GB, and the remaining 11.5 GB is reallocated as the operating region of the application program 40 itself. As a result, the operating region for the work processing of step 405 increases from 2.5 GB to 11.5 GB, and thus the application program 40 is able to enhance the work throughput.

Note that since only virtual memory space can be ensured in a typical application program, the magnitude of the virtual memory and the amount of actual memory used do not always match one to one. However, if virtual memory is used up to an amount of memory equal to the actual memory minus a fixed required capacity such as the OS usage amount, the entire virtual memory amount used in the system can be suppressed to or below the actual memory. In this state, all of the regions used by the application program are stored in the actual memory (page-outs are eliminated) and thus operations can be performed with a high degree of efficiency.

As an example in which CPUs are increased, an application program 40 of a type which performs work processing by activating an equal number of processes (including cases such as threads which are examples of processing units) to the number of packaged CPUs is envisaged. In the case of a computer installed with four CPUs, information indicating four CPUs is obtained in step 401 and information indicating that the license key 17 permits the operation of four CPUs is obtained in step 402. According to the determination in step 403, “HW configuration=license key”, and therefore processing moves to step 407. In step 407 four processes are activated in accordance with the four CPUs indicated by the license key 17, and in step 405 work processing is performed using the four processes.

When COD is implemented during the work processing in step 405 to increase the number of CPUs to eight, the hardware configuration becomes eight CPUs and the license key 17 begins to indicate eight CPUs. The application program 40 is then interrupted in step 409. The steps are then retraced in succession, and in step 407 eight processes are activated in accordance with the setting when the application program 40 operates on eight CPUs. As a result, the number of processes for the work processing in step 405 is increased from four to eight, and thus the application program is able to enhance work throughput.

Note that although FIGS. 7 and 6 were described separately, this is merely in order to simplify the description of the constitutional elements therein, and the two systems may be applied to a single embodiment. For example, the processing in steps 404 and 406 in FIG. 6 (checking the period of validity of the license) may be applied to FIG. 7, and the processing in steps 403 and 406 (halting the application when unauthorized usage is determined) may be applied to FIG. 7.

Following COD implementation, the AP vendor 30 requests payment of a fee corresponding to the new hardware configuration from each client. The AP billing management unit 32 in FIG. 1 is positioned on the AP vendor side, but in actuality a different company to the AP vendor 30 such as a reseller or a system constitution may be employed. The AP billing management unit 32 requests payment of a fee corresponding to the new hardware configuration from the AP fee paying control unit 18 of the client 10.

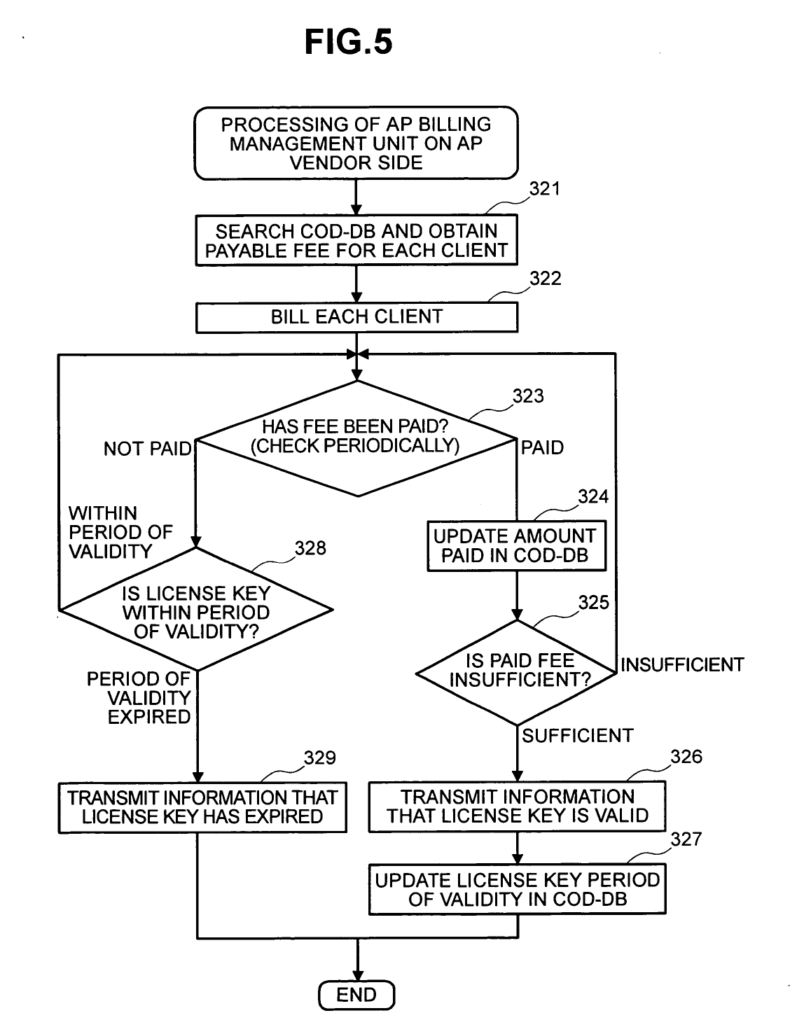

FIG. 5 is a flowchart of the AP billing management unit 32. First, in a step 321, the COD-DB 33 is searched to detect the sum to be billed to the client from the fees 3315 noted for each COD state, and then, in a step 322, the client is billed for the fee. Next, in a step 323, a check is performed as to whether or not the fee has been paid for example at 12 o'clock every day. If the fee has not been paid, the period of validity 3306 of the license key is checked on the COD-DB 33 in a step 328, and if the period of validity has expired, a license key indicating that no usage rights whatsoever exist is transmitted in a step 329. If the period of validity has not expired, processing returns to step 323 and payment is awaited once again. Note that if the fee has been paid, the payment received 3305 in the COD-DB 33 is updated in a step 324. In a step 325, a check is performed as to whether the amount paid is sufficient or not by comparing the amount paid with the fees 3315 for each COD state. If the amount is insufficient, processing returns to step 323 to await payment. If the amount is sufficient, the next payment deadline is determined and a license key with a new period of validity is transmitted to the client in a step 326. In a step 327, the period of validity 3306 in the COD-DB 33 is updated.

If usage is controlled with a license key which does not comprise information regarding a period of validity, a problem arises in that if a communication path is severed such that communication cannot be performed immediately after obtaining a license key corresponding to a hardware configuration following COD implementation, limitations on the operation of the application program 40 cannot be imposed from the AP vendor 30 side even when unauthorized usage is performed. By applying a period of validity to the license key 17 itself, unauthorized usage can be prevented. If the period of validity of the license key 17 has expired, the application program 40 stops operating in accordance with the judgement made in step 404 of FIG. 6, and thus unauthorized usage following COD implementation can be prevented.

Examples of automatic updating of the license key in this case will now be described. In one example, the application program 40 itself, after detecting that the period of validity of the license key 17 has expired, requests and obtains a new license key from the AP vendor 30. In another method, the AP vendor 30 references the license key period of validity 3306 in the COD-DB 33 comprised within itself and transmits the new license key 17. In either case, the license key 17 cannot be updated when the communication path is severed, and thus when the period of validity of the license key 17 within the client system 10 expires, unauthorized usage can be prevented. This embodiment of license key update processing is merely illustrative and does not limit the scope of the present invention.

Typically, prior to introducing a COD supporting system and beginning actual operations, COD is implemented temporarily for several months in order to perform an operations test of the entire system including a work application program or a performance test in a state following COD implementation. In this case also, transmission and reception of a license key for use with temporary COD implementation may be performed using the mechanisms of the present embodiment described above.

As described above, a work application program which operates on hardware introduced in a COD format can be used on hardware resources augmented by COD immediately after COD implementation, and thus throughput in the work of a client can be enhanced in a short period of time. Furthermore, if an appropriate usage fee for the application program is not paid after an increase in hardware resources such that usage becomes unauthorized, ways are provided to limit or halt the processing capacity of the application program until the appropriate fee has been paid, and thus unauthorized usage may be prevented.

In accordance with another feature, the client system 10 upon receiving the billing information for the modified hardware and the modified program, determines whether or not the hardware configuration and program configuration contained in the transmitted license information match with the modified hardware and modified program corresponding to the received billing information. If the hardware configuration and program configuration contained in the transmitted license information do not match with the modified hardware and modified program corresponding to the received billing information, then the configuration modification of the computer is halted.

According to the present embodiment, the capacity of a program can be modified to reflect modifications in a hardware configuration.

The above-described arrangements of apparatus and methods are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

1. A computer configuration modification method comprising:
storing hardware configuration information comprising information regarding hardware configuration of a computer, a hardware contract renewal notification destination for the hardware of the computer, information regarding program configuration of the computer, and a program contract renewal notification destination for the program of the computer;
upon reception of a configuration modification request for the hardware configuration and program configuration of the computer to be modified, transmitting the information regarding the hardware configuration to be modified to the hardware contract renewal notification destination in order to modify the fee to be paid for the modified hardware, and transmitting the information regarding the hardware configuration to be modified and the information regarding the program configuration to be modified to the program contract renewal notification destination in order to modify the fee to be paid for the modified program; and
when license information transmitted from the program contract renewal notification destination is inputted, modifying the hardware configuration based on the information regarding the hardware configuration to be modified and modifying the program configuration based on the information regarding the hardware configuration to be modified and the information regarding the program configuration to be modified.

2. The computer configuration modification method according to claim 1, wherein the license information includes a license key, and wherein the hardware configuration and the program configuration of the computer are modified based on the license key.

3. The computer configuration modification method according to claim 2, further comprising making a determination as to whether or not to perform the configuration modification based on a period of validity comprised in the license key.

4. The computer configuration modification method of claim 2, further comprising:
comparing the hardware configuration with the license key;
if the license key contains a permissible hardware amount which is smaller than an actual hardware amount of the hardware configuration, then modifying a hardware amount used by the program of the computer to the permissible hardware amount indicated by the license key; and
if the license key contains a permissible hardware amount which is greater than the actual hardware amount of the hardware configuration, then modifying a hardware amount used by the program of the computer to the actual hardware amount of the hardware configuration.

5. The computer configuration modification method according to claim 1, wherein when the configuration modification is performed, the configuration of the program is modified based on the modified hardware configuration.

6. The computer configuration modification method according to claim 1, further comprising:
receiving billing information for the modified hardware and the modified program;
determining whether or not the hardware configuration and program configuration contained in the transmitted license information match with the modified hardware and modified program corresponding to the received billing information; and
if the hardware configuration and program configuration contained in the transmitted license information do not match with the modified hardware and modified program corresponding to the received billing information, then halting the configuration modification of the computer.

7. The computer configuration modification method according to claim 1, wherein the hardware configuration is modified when license information transmitted from the hardware contract renewal notification destination and license information transmitted from the program contact renewal notification destination are inputted.

8. In a computer readable medium containing a computer configuration modification program for modifying configuration of a computer, the computer configuration modification program comprising:
code for storing hardware configuration information comprising information regarding hardware configuration of a computer, a hardware contract renewal notification destination for the hardware of the computer, information regarding program configuration of the computer, and a program contract renewal notification destination for the program of the computer;
code for, upon reception of a configuration modification request for the hardware configuration and program configuration of the computer to be modified, transmitting the information regarding the hardware configuration to be modified to the hardware contract renewal notification destination in order to modify the fee to be paid for the modified hardware, and transmitting the information regarding the hardware configuration to be modified and the information regarding the program configuration to be modified to the program contract renewal notification destination in order to modify the fee to be paid for the modified program; and
code for modifying the hardware configuration based on the information regarding the hardware configuration to be modified and modifying the program configuration based on the information regarding the hardware configuration to be modified and the information regarding the program configuration to be modified, when license information transmitted from the program contract renewal notification destination is inputted.

9. The computer configuration modification program according to claim 8, wherein the code for modifying comprises code for modifying the configuration of the computer based on a license key which is included in the license information.

10. The computer configuration modification program according to claim 9, further comprising code for determining whether or not to perform the configuration modification based on a period of validity comprised in the license key.

11. The computer configuration modification program according to claim 9, further comprising:
code for comparing the hardware configuration with the license key;
code for modifying a hardware amount used by the program of the computer to the permissible hardware amount indicated by the license key, upon determining that the license key contains a permissible hardware amount which is smaller than an actual hardware amount of the hardware configuration; and
code for modifying a hardware amount used by the program of the computer to the actual hardware amount of the hardware configuration, upon determining that the license key contains a permissible hardware amount which is greater than the actual hardware amount of the hardware configuration.

12. The computer configuration modification program according to claim 8, wherein the code for modifying comprises code for modifying the program configuration based on the modified hardware configuration when the configuration modification is performed.

13. The computer configuration modification program according to claim 8, further comprising
code for determining whether or not the hardware configuration and program configuration contained in the transmitted license information match with the modified hardware and modified program corresponding to billing information for the configuration modification; and
code for halting the configuration modification of the computer, upon determining that the hardware configuration and program configuration contained in the transmitted license information do not match with the modified hardware and modified program corresponding to the received billing information.

14. A computer configuration modification device comprising:
a memory configured to store hardware configuration information comprising information regarding hardware configuration of a computer, a hardware contract renewal notification destination for the hardware of the computer, information regarding program configuration of the computer, and a program contract renewal notification destination for the program of the computer;
means, upon reception of a configuration modification request for the hardware configuration and program configuration of the computer to be modified, for transmitting the information regarding the hardware configuration to be modified to the hardware contract renewal notification destination in order to modify the fee to be paid for the modified hardware, and transmitting the information regarding the hardware configuration to be modified and the information regarding the program configuration to be modified to the program contract renewal notification destination in order to modify the fee to be paid for the modified program; and
means, when license information transmitted from the program contract renewal notification destination is inputted, for modifying the hardware configuration based on the information regarding the hardware configuration to be modified and modifying the program configuration based on the information regarding the hardware configuration to be modified and the information regarding the program configuration to be modified.

15. The computer configuration modification device according to claim 14, further comprising means for modifying the configuration of the computer based on a license key which is included in the license information.

16. The computer configuration modification device according to claim 15, wherein the license key includes a period of validity for modifying the configuration of the computer.

17. The computer configuration modification device according to claim 15, further comprising:
means, if the license key contains a permissible hardware amount which is smaller than an actual hardware amount of the hardware configuration, for modifying a hardware amount used by the program of the computer to the permissible hardware amount indicated by the license key, and if the license key contains a permissible hardware amount which is greater than the actual hardware amount of the hardware configuration, for modifying a hardware amount used by the program of the computer to the actual hardware amount of the hardware configuration.

18. The computer configuration modification device according to claim 14, further comprising:
means for determining whether or not the hardware configuration and program configuration contained in the transmitted license information match with the modified hardware and modified program corresponding to billing information for the modified hardware and modified program; and
means, if the hardware configuration and program configuration contained in the transmitted license information do not match with the modified hardware and modified program corresponding to the received billing information, for halting the configuration modification of the computer.

19. A computer configuration modification system comprising:
a computer having a modifiable configuration;
a hardware management system configured to perform billing in accordance with hardware configuration of the computer; and
a program management system configured to perform billing in accordance with the program configuration of the computer;
wherein the computer is configured, when a configuration modification request for the hardware configuration and program configuration of the computer is inputted, to transmit to the hardware management system information regarding the hardware configuration to be modified in order to modify the fee to be paid for the hardware following configuration modification, and to transmit to the program management system information regarding the program configuration to be modified together with the information regarding the hardware configuration to be modified in order to modify the fee to be paid for the program following configuration modification;
wherein the hardware management system is configured, when the information regarding the hardware configuration to be modified is inputted, to modify the fee to be paid for the hardware based on the hardware configuration information and to transmit hardware billing information to the computer;
wherein the program management system is configured, when the information regarding the hardware configuration to be modified and the information regarding the program configuration to be modified is inputted, to modify the fee to be paid for the program based on the hardware configuration information and program configuration information and to transmit program billing information to the computer; and
wherein the computer is configured, when the hardware billing information and the program billing information are inputted, to modify the hardware configuration based on the information regarding the hardware configuration to be modified and to modify the program configuration based on the information regarding the program configuration to be modified.

20. The computer configuration modification system according to claim 19, wherein the hardware configuration and the program configuration of the computer are modified based on a license key generated by the program management system.

21. The computer configuration modification system according to claim 20, wherein the license key includes a period of validity for modifying the configuration of the computer.

22. The computer configuration modification system according to claim 20, wherein the license key contains permissible hardware configuration and permissible program configuration, and wherein the computer is configured not to modify the hardware configuration and the program configuration if the hardware configuration and the program configuration corresponding to the billing information do not match the permissible hardware configuration and the permissible program configuration contained in the license key.

23. The computer configuration modification system according to claim 19, wherein the computer is configured to modify the program configuration based on the modified hardware configuration.
